(19) United States
(12) Patent Application Publication
(10) Pub. No.: US 2017/0107689 A1
(43) Pub. Date: Apr. 20, 2017

(54) SUPPORT STRUCTURE FOR FRAME OF A MACHINE

(71) Applicant: Caterpillar Inc., Peoria, IL (US)

(72) Inventors: Travis Ducheneaux, Dunlap, IL (US); Kevin Miller, Morton, IL (US); Roy Maske, Eureka, IL (US); Michael Ross Haughney, Peoria, IL (US); Rohit Gujarathi, Peoria, IL (US)

(73) Assignee: CATERPILLAR INC., Peoria, IL (US)

(21) Appl. No.: 14/882,509

(22) Filed: Oct. 14, 2015

(51) Int. Cl. E02F 9/08; B62D 33/077; B62D 33/06; F16M 13/02; E02F 3/76

(52) U.S. Cl. CPC E02F 9/0808; F16M 13/02; E02F 3/7609; B62D 33/0617; B62D 33/077

(57) ABSTRACT

A support structure for a frame of a machine including a frame mount for attaching the support structure to the frame, the frame mount defining a bottom portion of the support structure. A cylinder mount formed above the frame mount for pivotally mounting a lift cylinder to the frame and a cab mount formed above the frame mount for mounting a cab structure.

### TECHNICAL FIELD

Present disclosure relates to a support structure for construction machines. In particular, present disclosure relates to a support structure for a frame of a construction machine.

### BACKGROUND

Frame of the construction machines may be mounted with different kind of implements for performing various operations. In addition to the implements, the frame of a construction machine also supports various other components of the construction machine, for example engine, tracks or wheels, operator cabin, roll over protection system (ROPS), lights, etc. Support structures are provided on the frame for mounting different components of the construction machine. The support structures may be integral with frame or may be mounted on the frame as required.

In track type dozers, the front portion of the frame generally provides for a mounting arrangement for lift cylinders that lift an implement such as a dozer blade. In addition to the support structure for lift cylinders, the front portion of the frame also provides a support structure on which the operator cabin can be mounted. These structures may add up to number of components on the frame. Further, these structures may also affect accessibility of the components mounted on the frame. For example, the support structures for the lift cylinder and the operator cabin may hamper the accessibility of the engine mounted on the frame during service or maintenance.

Further, as the frame also supports the tracks or wheels used as earth engagement means mounted on the outer side of the frame, the support structures for the lift cylinder and the operator cabin may reduce the effective clearance between the frame and the tracks. The present disclosure addresses one or more issues with support structure for the lift cylinders.

U.S. Pat. No. 8,770,908 discloses a support structure located between lift arms of the machine. A tilt cylinder may be mounted on the support structure to control an articulating implement.

### SUMMARY OF THE INVENTION

A support structure for a frame of a machine including a frame mount for attaching the support structure to the frame, the frame mount defining a bottom portion of the support structure. A cylinder mount formed above the frame mount for pivotally mounting a lift cylinder to the frame and a cab mount formed above the frame mount for mounting a cab structure.

A machine including a frame extending longitudinally between the front and back of the machine. The machine including an engine mounted within the frame. A support structure defining a frame mount, a cylinder mount and a cab mount with the frame mount forming a bottom portion of the support structure and the cylinder mount and the cab mount formed above the frame mount. The support structure attached to the frame by the frame mount. A cylinder pivotally mounted on the cylinder mount and a cab structure mounted on the cab mount.

### BRIEF DESCRIPTION OF THE DRAWINGS

FIG. 1 illustrates a schematic diagram of a construction machine.

FIG. 2 illustrates a perspective view of a frame for a construction machine.

FIG. 3 illustrates a perspective view of a support structure for a frame of a construction machine

FIG. 4 illustrates a perspective view of a support structure mounted on a frame of a construction machine.

FIG. 5 illustrates a perspective view of a support structure mounted on a frame of a construction machine.

FIG. 6 illustrates a top view of the support structure mounted on a frame of a construction machine.

### DETAILED DESCRIPTION

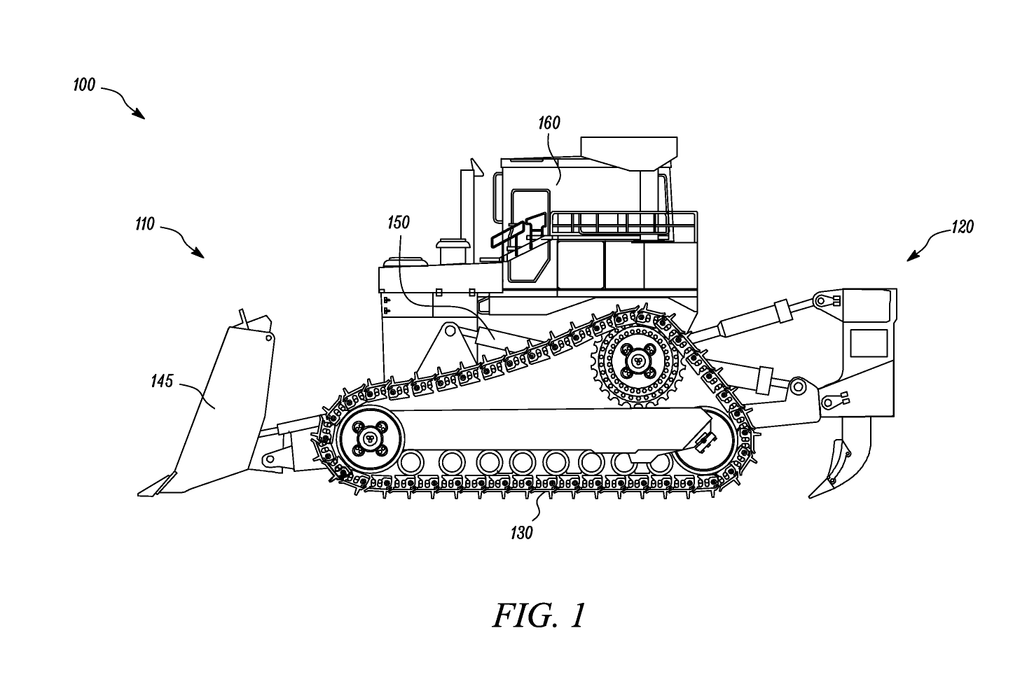

FIG. 1 illustrates a construction machine 100, for example a dozer. The construction machine 100 may have a front 110, a back 120 and earth engagement means. Further, the earth engagement means may be wheels or tracks. In the embodiment as illustrated, the construction machine 100 has tracks 130. Further, the construction machine 100 may have an implement 145 and a cylinder 150 coupled to the implement 145. The cylinder 500 may be configured for moving or lifting the implement 145. The construction machine 100 may further have a frame 200.

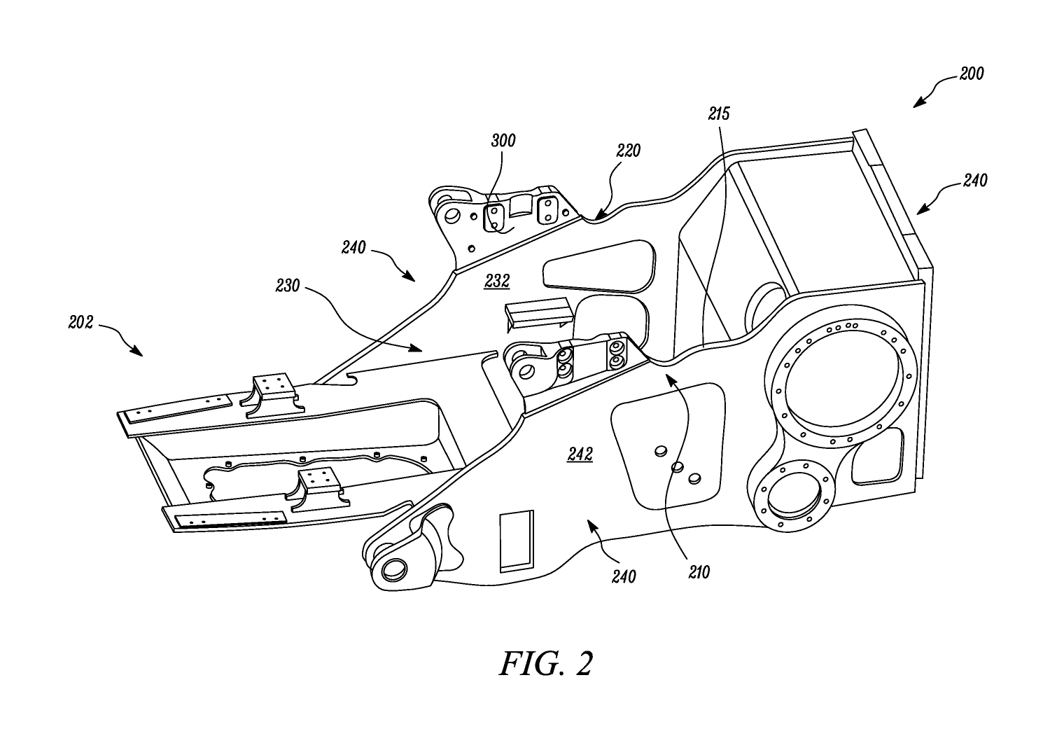

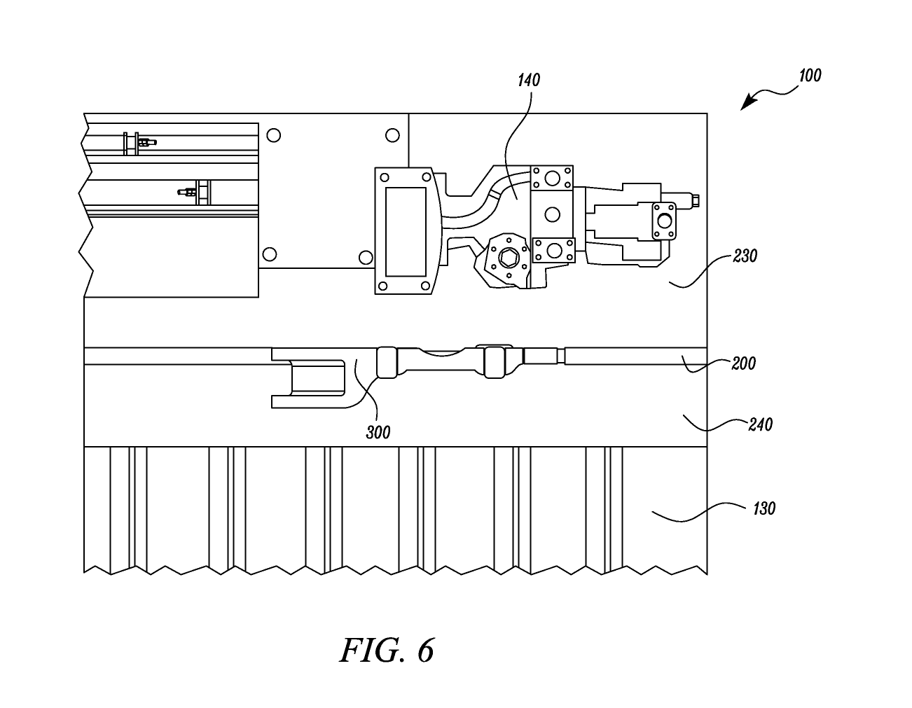

FIG. 2 illustrates a frame 200 for the construction machine 100. The frame 200 may extend longitudinally between a front 110 and back 120 of a construction machine 100. The frame 200 may have a first side arm 210 and a second side arm 220 both extending parallel to the direction of travel of the construction machine 100. The side arms 210,220 may be of substantially plate like shape with the surface of the two plate like side arms 210,220 oriented vertically and substantially parallel to each other. The two side arms 210,220 may define an inboard side 230 between the two side arms 210,220 and an outboard side 240 on the outer side of the frame 200. The inboard side 230 may house different components of the dozer, for example an engine 140 (shown in FIG. 6). Each of the side arms 210,220 may further have an inboard surface 232 and an outboard surface 242. Further, each of the first and the second side arms 210,220 may have an upper ridge 215 running along the upper thickness of the side arms 210,220. The frame 200 may have a front portion 202 and a back portion 204.

A support structure 300 may be attached to the upper ridge 215 of the side arms 210,220. Each side arm may be attached with one support structure 300 as illustrated in FIG. 2.

The support structure 300 may be a single cast piece. The support structure 300 may have a frame mount 320 defining a bottom portion of the support structure 300. The frame mount 320 may be configured for attachment to the frame 200 of the construction machine 100. The frame mount 320 may have a lower edge 322 configured for attachment to the upper ridge 215 of the frame 200. In an embodiment, the frame mount 320 may have two spaced apart support surfaces for receiving the upper ridge 215 of the frame 200. The support structure 300 may be attached to the side arms 210,220 by any known method in the art, for example welding.

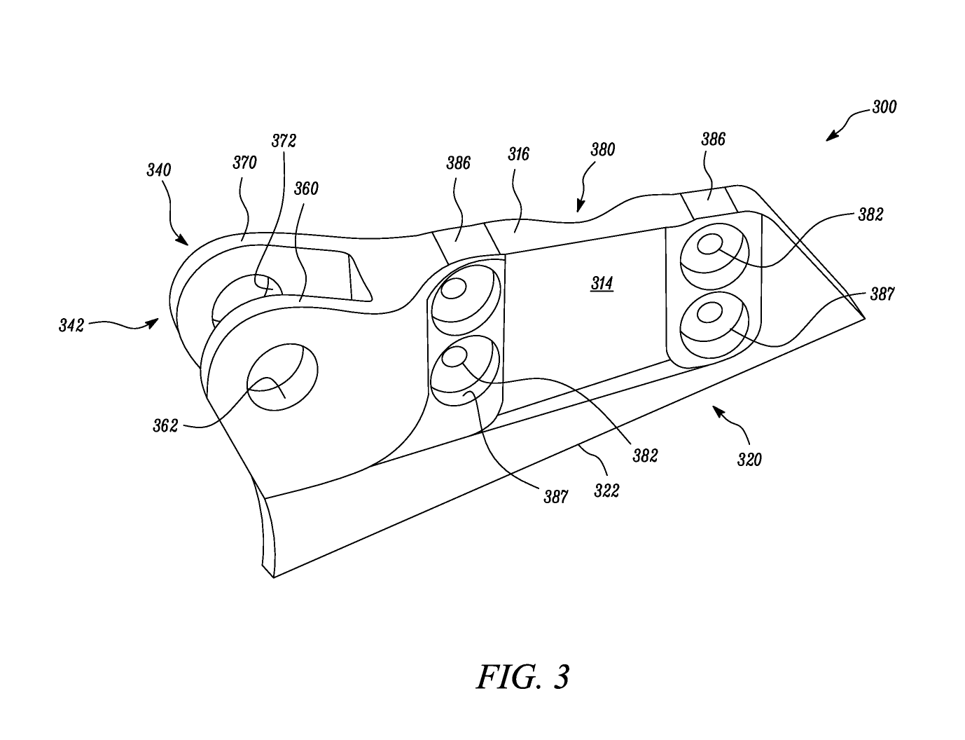

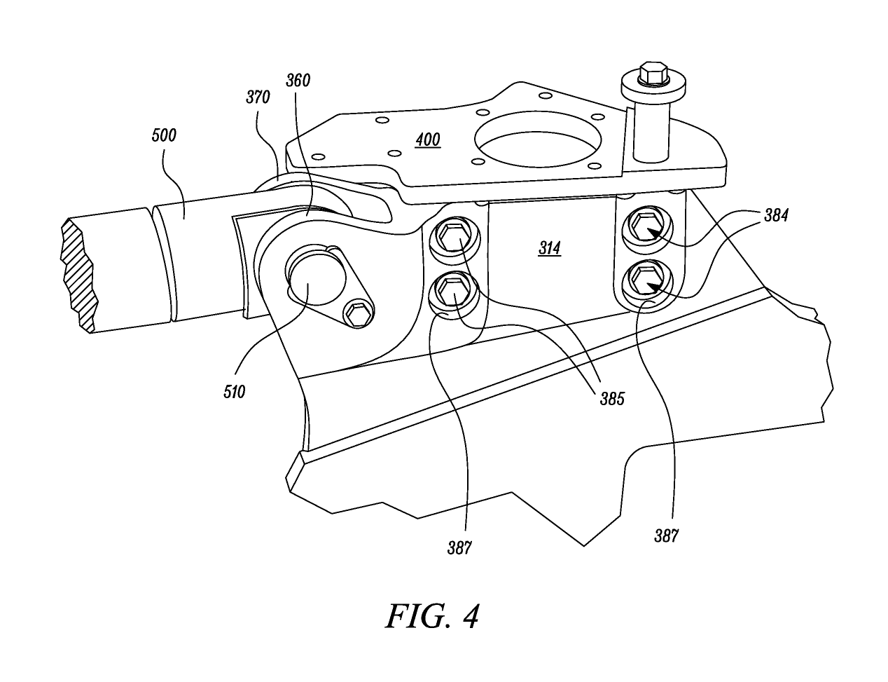

Further, referring to FIG. 3 and FIG. 4, the support structure 300 may have a cylinder mount 340 for mounting a lift cylinder and a cab mount 380 for mounting a cab structure 400. The cylinder mount 340 may be formed above the frame mount 320. The cylinder mount 340 on the support structure 300 may provide a support for coupling a cylinder 500. In the embodiment illustrated, the cylinder 500 is coupled on the cylinder mount 340 by a pin 510.

The cylinder mount 340 may provide for a fork end 342 with a first arm 360 and a second arm 370 spaced apart from each other. The first arm 360 and the second arm 370 are formed integrally with the support structure 300. Each arm 360,370 may have eyes 362, 372 to receive the pin 510 to pivotally couple an eye (not shown) of the cylinder 500 to the frame 200 of the construction machine 100. In the embodiment as illustrated, the cylinder 500 has an eye and the support structure 300 is provided with a fork end 342, in an alternate embodiment, the support structure 300 may be provided with an eye and the lift cylinder 500 may have a fork end for coupling the lift cylinder 500 to the support structure 300.

The support structure 300 may be mounted on the frame 200 with the cylinder mount 340 towards the front portion 230 of the frame 200. In the embodiment illustrated in FIG. 4, a lift cylinder 500 is pivotally mounted to the support structure 300 on the frame 200. A pin 510 may be used to pivotally couple the cylinder 500 to the cylinder mount 340. The fork end of the cylinder mount 340 may be oriented parallel to the frame 200 so as to receive the pin 510 in a horizontal direction. The cylinder 500 may be a lift cylinder or any other cylinder that is required to be mounted to the frame 200.

The support structure 300 may define a first side surface 312, a second side surface 314 and a top surface 316. In an embodiment, the first and the second side surfaces 312,314 may be flush with the inboard surface 232 and the outboard surface 242 of the frame 200, respectively.

Further, the support structure 300 may have a cab mount 380 formed above the frame mount 320 for mounting a cab structure 400. The cab structure 400 may be a part of the operator cabin 160 and may be configured for mounting the operator cabin 160 on the support structure 300. The cab mount 380 may provide for a mount location for mounting the cab structure 400. The cab mount 380 may define either the first side surface 312 or the second side surface 314 of the support structure 300. In other embodiments, the cab mount 380 may define the top surface 316 of the support structure 300. In other embodiments, the cab mount 380 may define a side surface 312, 314 and the top surface 316 of the support structure 300.

The support structure 300 may define one or more openings 382. The openings 382 are configured to receive mounting structures or fasteners for mounting the support structure 300 to the frame 200 or for mounting one or more structures to the support structure 300. The openings 382 may be provided on the side surface 312, 314 or a top surface 316 of the support structure 300.

In an embodiment, the cab mount 280 may define the openings 382. The openings 382 may extend from the first side surface 312 to the second side surface 314. The openings 382 may be configured to receive fasteners 384 for fastening an operator cab or a Roll Over Protection System (ROPS) to the support structure 300. In an embodiment, the second side surface 314 may have recessed openings 387 to receive fastener heads 385. The recessed openings 387 may protect the fastener heads 385 from any mud or dust deposits.

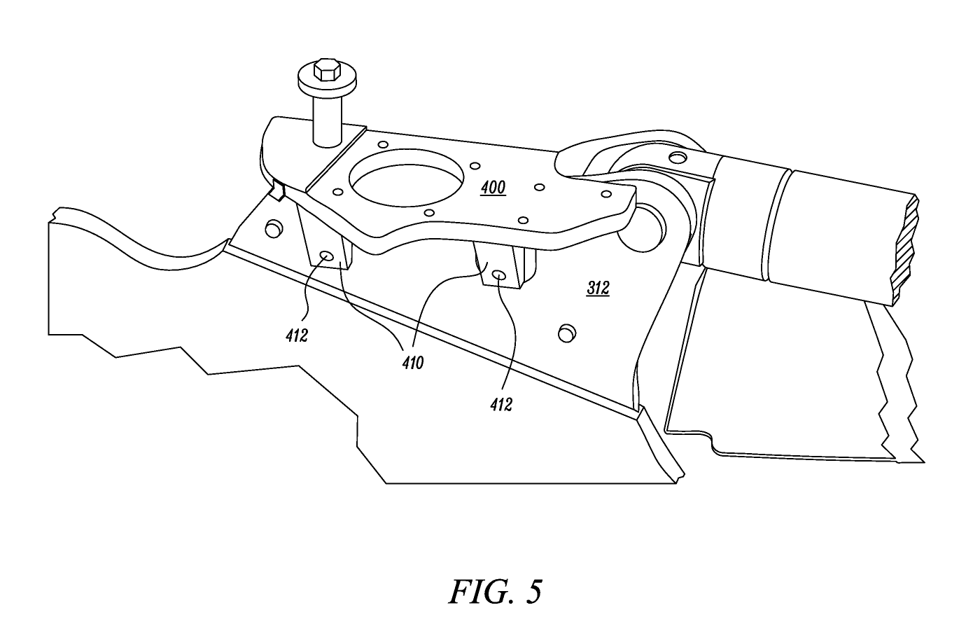

Further, the cab mount 380 may include an abutment surface 386 on the top surface 316 of the support structure 300. The abutment surface 386 may be configured to provide a support surface for mounting the cab structure 400 of the operator cabin 160. FIGS. 4 and 5 illustrate a cab structure 400 mounted to the cab mount 380 of the support structure 300. The cab mount 380 may also provide for a mounting arrangement for a roll over protection system for a construction machine 100.

The cab structure 400 may be configured to provide a mounting structure for mounting the operator cabin. Referring to FIG. 5, the cab structure 400 may have legs 410 with fastener openings 412. The fastener openings on the legs 410 may correspond with openings 382 in the cab mount 380 such that the cab structure 400 may be fastened to the support structure 300 using fasteners 384 extending through the legs 410 and the cab mount 380. In an embodiment, the fasteners 384 may be bolts and nuts. In another embodiment, the fastener openings 412 in the legs 310 may have threads for fastening the bolt directly in the legs.

### INDUSTRIAL APPLICABILITY

The support structure 300 for a frame 200 is designed and arranged to keep adequate clearance for service, installation or maintenance, as required, for various components mounted on the frame 200. The present disclosure may provide for a common support structure 300 for mounting a cab structure 400 and a cylinder 500. The support structure 300 according to the present disclosure may provide for a compact support structure 300 that does not reduce the required clearance towards the inboard side 230 of the frame 200. As illustrated in FIG. 6, this may provide adequate clearance at the inboard side 230 for installation, access or operation of the components that are mounted inboard side 230 of the frame 200. For example, the support structure 300 in accordance with the present disclosure may provide for enough clearance such that an engine 140 of the construction machine 100 may be installed or removed without disassembling the cylinder 500, support structure 300 or the cab structure 400.

Further the support structure 300 in accordance with the present disclosure may likewise protrude very minimally towards the outboard side 240. The compact dimensions of the support structure 300 may provide for adequate clearance for the components mounted on the outboard side 240 of the frame 200. For example, tracks 130 are mounted on the outboard side 240 of the frame 200. There may be movement in the tracks 130 during the movement of the construction machine 100. As illustrated in FIG. 6, the frame 200 and the support structure 300 mounted on the frame 200 may provide for adequate clearance for movement operation of the tracks 130 mounted on the outboard side of the frame 200 near the side arms 210,220 of the frame 200.

Further, the support structure 300 in accordance with the present disclosure may provide for a single support structure 300 configured for mounting both, the cab structure 400 and the cylinder 500. Thus, present disclosure may provide for reduced number of parts in the construction machine 100. Furthermore, the single cast piece support structure 300 in accordance with the present disclosure may be easy and cost effective to manufacture and install on the frame 200.

what is claimed is:

1. A support structure for a frame of a machine comprising:
a frame mount for attaching the support structure to the frame; the frame mount defining a bottom portion of the support structure;
a cylinder mount formed above the frame mount for pivotally mounting a lift cylinder to the frame; and
a cab mount formed above the frame mount for mounting a cab structure.

2. The support structure of claim 1, wherein the frame mount includes a pair of spaced apart support surfaces configured to receive the frame.

3. The support structure of claim 1, wherein the cab mount defines a side surface of the support structure.

4. The support structure of claim 1, wherein the cab mount is configured for attachment of the cab structure on an inner wall of the support structure.

5. The support structure of claim 1, wherein the cab mount defines a top surface of the support structure.

6. The cab structure of claim 1 wherein the cab mount defines an opening on the side surface of the support structure.

7. The support structure of claim 1, wherein a side surface of the support structure defines one or more openings for receiving fasteners.

8. The support structure of claim 1, wherein the cylinder mount includes a pair of spaced apart support surfaces defining a hole for receiving a pin.

9. The support structure of claim 1, wherein the cab mount is configured for mounting a roll over protection system of the machine.

10. A machine comprising:
a frame extending longitudinally between the front and back of the machine;
an engine mounted within the frame;
a support structure defining a frame mount, a cylinder mount and a cab mount with the frame mount forming a bottom portion of the support structure and the cylinder mount and the cab mount formed above the frame mount; the support structure attached to the frame by the frame mount;
a cylinder pivotally mounted on the cylinder mount; and
a cab structure mounted on the cab mount.

11. The machine of claim 10, wherein the frame mount includes a pair of spaced apart support surfaces configured to receive the frame.

12. The machine of claim 10, wherein the cab mount defines a side surface of the support structure.

13. The machine of claim 10, wherein the cab structure is mounted on an inner wall of the cab mount.

14. The machine of claim 10, wherein the cab mount defines a top surface of the support structure.

15. The machine of claim 10, wherein a side surface of the support structure defines one or more openings for receiving fasteners.

16. The machine of claim 10, wherein the support structure has one or more openings.

17. The machine of claim 10, wherein the cylinder mount includes a pair of spaced apart support surfaces defining a hole for receiving an end of the cylinder.

18. The machine of claim 10, wherein the cab structure is a part of the roll over protection system of the construction machine.

19. The machine of claim 10, wherein the cylinder is a lift cylinder.

20. The machine of claim 10, wherein the support structure defines a first clearance with a track outside the frame and a second clearance with the engine within the frame.
